(19) United States
(12) Patent Application Publication
(10) Pub. No.: US 2015/0222408 A1
(43) Pub. Date: Aug. 6, 2015

(54) EPHICH FOR LTE NETWORKS WITH UNLICENSED SPECTRUM

(71) Applicant: QUALCOMM Incorporated, San Diego, CA (US)

(72) Inventors: Srinivas Yerramalli, San Diego, CA (US); Tao Luo, San Diego, CA (US); Hao Xu, San Diego, CA (US); Peter Gaal, San Diego, CA (US); Wanshi Chen, San Diego, CA (US); Aleksandar Damnjanovic, Del Mar, CA (US); Tingfang Ji, San Diego, CA (US); Shimman Arvind Patel, San Diego, CA (US)

(21) Appl. No.: 14/612,779

(22) Filed: Feb. 3, 2015

Related U.S. Application Data
(60) Provisional application No. 61/935,645, filed on Feb. 4, 2014.

(51) Int. Cl. H04L 5/00; H04L 1/16; H04W 72/00

(52) U.S. Cl. CPC H04L 5/0055; H04L 5/0048; H04W 72/005; H04L 1/1671

(57) ABSTRACT

An enhanced acknowledgement indicator channel is discussed that multiplexes acknowledgement signals for multiple uplink signals from various user equipments (UEs) into the enhanced acknowledgement indicator channel. The channel is divided into a number of paired data and pilot resource element groups that can be precoded independently of one another, such that each paired resource element group is precoded using a different or independent precoding than the other paired resource element groups. If the base station determines a failure to decode any uplink signals, instead of sending acknowledgement signals over the indicator channel, the base station may, instead, generate uplink grants for retransmission of the uplink signals.

### CROSS-REFERENCE TO RELATED APPLICATIONS

This application claims the benefit of U.S. Provisional Patent Application No. 61/935,645, entitled, “EPHICH FOR LTE NETWORKS WITH UNLICENSED SPECTRUM”, filed on Feb. 4, 2014, which is expressly incorporated by reference herein in its entirety.

### BACKGROUND

1. Field

Aspects of the present disclosure relate generally to wireless communication systems, and more particularly, to enhanced physical hybrid automatic repeat request indicator channel (EPHICH) for long term evolution (LTE) and LTE-Advanced (LTE-A) networks with unlicensed spectrum.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method of wireless communication includes generating a plurality of acknowledgment signals, wherein each of the plurality of acknowledgement signals corresponds to status of a plurality of uplink signals, multiplexing the plurality of acknowledgement signals into an acknowledgment indicator channel, wherein the acknowledgement indicator channel includes a plurality of data resource element groups and a plurality of pilot resource element groups paired with the plurality of data resource element groups, precoding one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding, and transmitting the acknowledgment indicator channel.

In an additional aspect of the disclosure, a method of wireless communication includes determining a downlink resource for receiving an acknowledgment indicator channel, detecting one or more pilot resource element groups of the acknowledgement indicator channel having a precoding corresponding to a configuration of a UE, determining a channel estimate for the acknowledgement indicator channel, wherein the channel estimate is based on the precoding, and decoding, using the channel estimate, one or more data resource element groups paired with the one or more pilot resource element groups in the acknowledgement indicator channel to obtain an acknowledgement related to an uplink signal transmitted by the UE, wherein the one or more data resource element groups are precoded using the precoding of the detected one or more pilot resource element groups.

In an additional aspect of the disclosure, a method of wireless communication includes detecting failure to decode one or more uplink signals of a plurality of uplink signals received from one or more UEs served by a base station, generating one or more uplink grants for retransmission of the one or more uplink signals in response to the failure to decode, and transmitting the one or more uplink grants in a downlink control channel.

In an additional aspect of the disclosure, a method of wireless communication includes failing to detect an acknowledgement indicator acknowledging an uplink signal transmitted to a serving base station, receiving an uplink grant in a downlink control channel from the serving base station, wherein the uplink grant provides uplink resources for retransmission of the uplink signal, and retransmitting the uplink signal in response to the uplink grant.

In an additional aspect of the disclosure, an apparatus configured for wireless communication includes means for generating a plurality of acknowledgment signals, wherein each of the plurality of acknowledgement signals corresponds to status of a plurality of uplink signals, means for multiplexing the plurality of acknowledgement signals into an acknowledgment indicator channel, wherein the acknowledgement indicator channel includes a plurality of data resource element groups and a plurality of pilot resource element groups paired with the plurality of data resource element groups, means for precoding one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding, and means for transmitting the acknowledgment indicator channel.

In an additional aspect of the disclosure, an apparatus configured for wireless communication includes means for determining a downlink resource for receiving an acknowledgment indicator channel, means for detecting one or more pilot resource element groups of the acknowledgement indicator channel having a precoding corresponding to a configuration of a UE, means for determining a channel estimate for the acknowledgement indicator channel, wherein the channel estimate is based on the precoding, and means for decoding, using the channel estimate, one or more data resource element groups paired with the one or more pilot resource element groups in the acknowledgement indicator channel to obtain an acknowledgement related to an uplink signal transmitted by the UE, wherein the one or more data resource element groups are precoded using the precoding of the detected one or more pilot resource element groups.

In an additional aspect of the disclosure, an apparatus configured for wireless communication includes means for detecting failure to decode one or more uplink signals of a plurality of uplink signals received from one or more UEs served by the base station, means for generating one or more uplink grants for retransmission of the one or more uplink signals in response to the failure to decode, and means for transmitting the one or more uplink grants in a downlink control channel.

In an additional aspect of the disclosure, an apparatus configured for wireless communication includes means for determining a failure to detect an acknowledgement indicator acknowledging an uplink signal transmitted to a serving base station, means for receiving an uplink grant in a downlink control channel from the serving base station, wherein the uplink grant provides uplink resources for retransmission of the uplink signal, and means for retransmitting the uplink signal in response to the uplink grant.

In an additional aspect of the disclosure, a non-transitory computer-readable medium having program code recorded thereon. This program code includes code to generate a plurality of acknowledgment signals, wherein each of the plurality of acknowledgement signals corresponds to status of a plurality of uplink signals, code to multiplex the plurality of acknowledgement signals into an acknowledgment indicator channel, wherein the acknowledgement indicator channel includes a plurality of data resource element groups and a plurality of pilot resource element groups paired with the plurality of data resource element groups, code to precode one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding, and code to transmit the acknowledgment indicator channel.

In an additional aspect of the disclosure, a non-transitory computer-readable medium having program code recorded thereon. This program code includes code to determine a downlink resource for receiving an acknowledgment indicator channel, code to detect one or more pilot resource element groups of the acknowledgement indicator channel having a precoding corresponding to a configuration of a UE, code to determine a channel estimate for the acknowledgement indicator channel, wherein the channel estimate is based on the precoding, and code to decode, using the channel estimate, one or more data resource element groups paired with the one or more pilot resource element groups in the acknowledgement indicator channel to obtain an acknowledgement related to an uplink signal transmitted by the UE, wherein the one or more data resource element groups are precoded using the precoding of the detected one or more pilot resource element groups.

In an additional aspect of the disclosure, a non-transitory computer-readable medium having program code recorded thereon. This program code includes code to detect failure to decode one or more uplink signals of a plurality of uplink signals received from one or more UEs served by the base station, code to generate one or more uplink grants for retransmission of the one or more uplink signals in response to the failure to decode, and code to transmit the one or more uplink grants in a downlink control channel.

In an additional aspect of the disclosure, a non-transitory computer-readable medium having program code recorded thereon. This program code includes code to determine a failure to detect an acknowledgement indicator acknowledging an uplink signal transmitted to a serving base station, code to receive an uplink grant in a downlink control channel from the serving base station, wherein the uplink grant provides uplink resources for retransmission of the uplink signal, and code to retransmit the uplink signal in response to the uplink grant.

### BRIEF DESCRIPTION OF THE DRAWINGS

FIG. 1 shows a diagram that illustrates an example of a wireless communications system according to various embodiments.

FIG. 2A shows a diagram that illustrates examples of deployment scenarios for using LTE in an unlicensed spectrum according to various embodiments.

FIG. 2B shows a diagram that illustrates another example of a deployment scenario for using LTE in an unlicensed spectrum according to various embodiments.

FIG. 3 shows a diagram that illustrates an example of carrier aggregation when using LTE concurrently in licensed and unlicensed spectrum according to various embodiments.

FIG. 4 is a block diagram conceptually illustrating a design of a base station/eNB and a UE configured according to one aspect of the present disclosure.

FIG. 5 is a block diagram illustrating a downlink subframe configured according to one aspect of the present disclosure.

FIG. 6 is a block diagram illustrating a downlink subframe configured according to one aspect of the present disclosure.

FIGS. 7A-7B are block diagrams illustrating downlink subframes configured according to aspects of the present disclosure.

FIGS. 8-11 are functional block diagrams illustrating example blocks executed to implement one aspect of the present disclosure.

FIG. 12 is a block diagram illustrating a network operating LTE/LTE-A with unlicensed spectrum and configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Operators have so far looked at WiFi as the primary mechanism to use unlicensed spectrum to relieve ever increasing levels of congestion in cellular networks. However, a new carrier type (NCT) based on LTE/LTE-A extending to unlicensed spectrum may be compatible with carrier-grade WiFi, making LTE/LTE-A with unlicensed spectrum an alternative to WiFi. LTE/LTE-A with unlicensed spectrum may leverage LTE concepts and may introduce some modifications to physical layer (PHY) and media access control (MAC) aspects of the network or network devices to provide efficient operation in the unlicensed spectrum and to meet regulatory requirements. The unlicensed spectrum may range from 600 Megahertz (MHz) to 6 Gigahertz (GHz), for example. In some scenarios, LTE/LTE-A with unlicensed spectrum may perform significantly better than WiFi. For example, an all LTE/LTE-A with unlicensed spectrum deployment (for single or multiple operators) compared to an all WiFi deployment, or when there are dense small cell deployments, LTE/LTE-A with unlicensed spectrum may perform significantly better than WiFi. LTE/LTE-A with unlicensed spectrum may perform better than WiFi in other scenarios such as when LTE/LTE-A with unlicensed spectrum is mixed with WiFi (for single or multiple operators).

For a single service provider (SP), an LTE/LTE-A network with unlicensed spectrum may be configured to be synchronous with a LTE network on the licensed spectrum. However, LTE/LTE-A networks with unlicensed spectrum deployed on a given channel by multiple SPs may be configured to be synchronous across the multiple SPs. One approach to incorporate both the above features may involve using a constant timing offset between LTE/LTE-A networks without unlicensed spectrum and LTE/LTE-A networks with unlicensed spectrum for a given SP. An LTE/LTE-A network with unlicensed spectrum may provide unicast and/or multicast services according to the needs of the SP. Moreover, an LTE/LTE-A network with unlicensed spectrum may operate in a bootstrapped mode in which LTE cells act as anchor and provide relevant cell information (e.g., radio frame timing, common channel configuration, system frame number or SFN, etc.) for LTE/LTE-A cells with unlicensed spectrum. In this mode, there may be close interworking between LTE/LTE-A without unlicensed spectrum and LTE/LTE-A with unlicensed spectrum. For example, the bootstrapped mode may support the supplemental downlink and the carrier aggregation modes described above. The PHY-MAC layers of the LTE/LTE-A network with unlicensed spectrum may operate in a standalone mode in which the LTE/LTE-A network with unlicensed spectrum operates independently from an LTE network without unlicensed spectrum. In this case, there may be a loose interworking between LTE without unlicensed spectrum and LTE/LTE-A with unlicensed spectrum based on RLC-level aggregation with co-located LTE/LTE-A with/without unlicensed spectrum cells, or multiflow across multiple cells and/or base stations, for example.

The techniques described herein are not limited to LTE, and may also be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

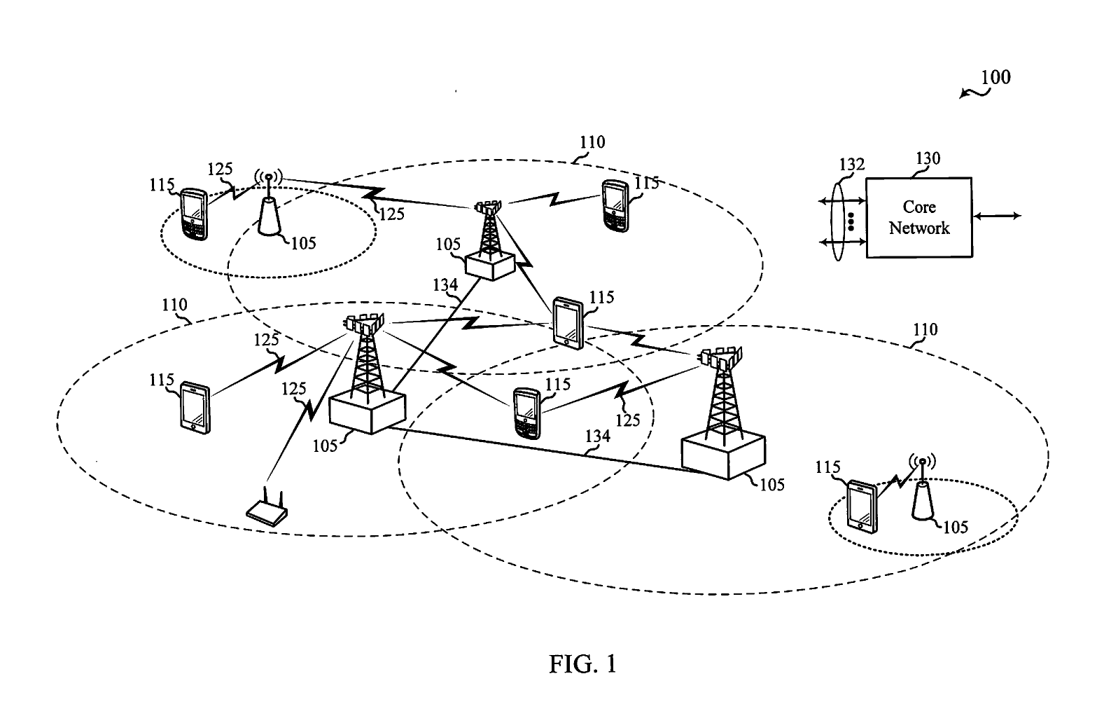

Referring first to FIG. 1, a diagram illustrates an example of a wireless communications system or network 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In some embodiments, the system 100 is an LTE/LTE-A network that supports one or more unlicensed spectrum modes of operation or deployment scenarios. In other embodiments, the system 100 may support wireless communications using an unlicensed spectrum and an access technology different from LTE/LTE-A with unlicensed spectrum, or a licensed spectrum and an access technology different from LTE/LTE-A. The terms evolved Node B (eNB) and user equipment (UE) may be generally used to describe the base stations 105 and devices 115, respectively. The system 100 may be a Heterogeneous LTE/LTE-A network with or without unlicensed spectrum in which different types of eNBs provide coverage for various geographical regions. For example, each eNB 105 may provide communication coverage for a macro cell, a pico cell, a femto cell, and/or other types of cell. Small cells such as pico cells, femto cells, and/or other types of cells may include low power nodes or LPNs. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul links 132 (e.g., through core network 130). The system 100 may support synchronous or asynchronous operation. For synchronous operation, the eNBs may have similar frame and/or gating timing, and transmissions from different eNBs may be approximately aligned in time. For asynchronous operation, the eNBs may have different frame and/or gating timing, and transmissions from different eNBs may not be aligned in time. The techniques described herein may be used for either synchronous or asynchronous operations.

The UEs 115 are dispersed throughout the system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communications links 125 shown in system 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions. The downlink transmissions may be made using a licensed spectrum (e.g., LTE), an unlicensed spectrum (e.g., LTE/LTE-A with unlicensed spectrum), or both (LTE/LTE-A with/without unlicensed spectrum). Similarly, the uplink transmissions may be made using a licensed spectrum (e.g., LTE), an unlicensed spectrum (e.g., LTE/LTE-A with unlicensed spectrum), or both (LTE/LTE-A with/without unlicensed spectrum).

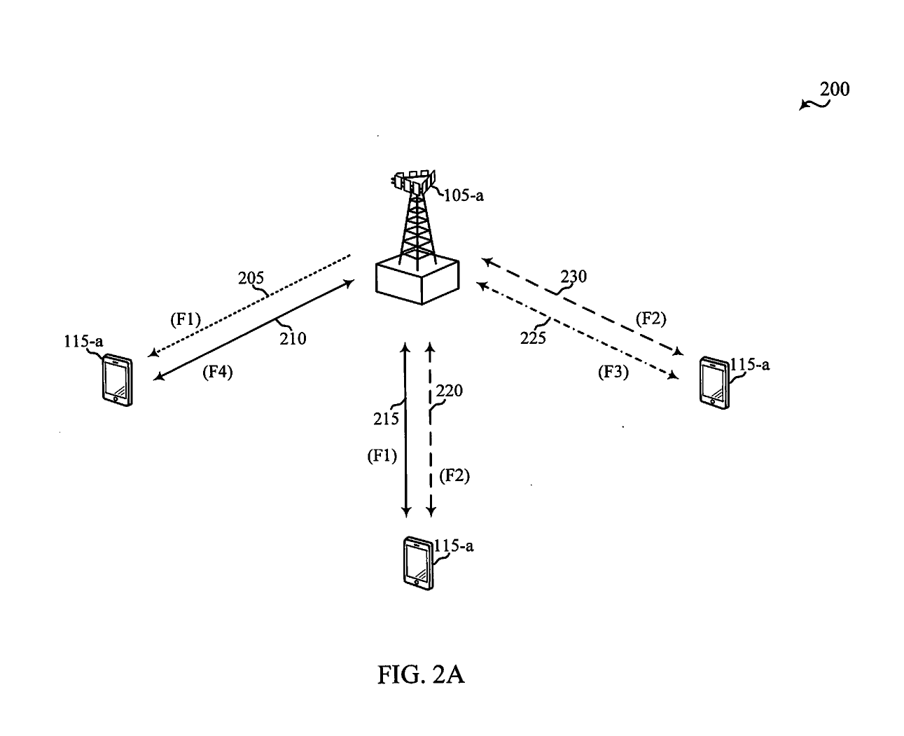

In some embodiments of the system 100, various deployment scenarios for LTE/LTE-A with unlicensed spectrum may be supported including a supplemental downlink (SDL) mode in which LTE downlink capacity in a licensed spectrum may be offloaded to an unlicensed spectrum, a carrier aggregation mode in which both LTE downlink and uplink capacity may be offloaded from a licensed spectrum to an unlicensed spectrum, and a standalone mode in which LTE downlink and uplink communications between a base station (e.g., eNB) and a UE may take place in an unlicensed spectrum. Base stations 105 as well as UEs 115 may support one or more of these or similar modes of operation. OFDMA communications signals may be used in the communications links 125 for LTE downlink transmissions in an unlicensed spectrum, while SC-FDMA communications signals may be used in the communications links 125 for LTE uplink transmissions in an unlicensed spectrum. Additional details regarding the implementation of LTE/LTE-A with unlicensed spectrum deployment scenarios or modes of operation in a system such as the system 100, as well as other features and functions related to the operation of LTE/LTE-A with unlicensed spectrum, are provided below with reference to FIGS. 2A-12.

Turning next to FIG. 2A, a diagram 200 shows examples of a supplemental downlink mode and of a carrier aggregation mode for an LTE network that supports LTE/LTE-A with unlicensed spectrum. The diagram 200 may be an example of portions of the system 100 of FIG. 1. Moreover, the base station 105-a may be an example of the base stations 105 of FIG. 1, while the UEs 115-a may be examples of the UEs 115 of FIG. 1.

In the example of a supplemental downlink mode in diagram 200, the base station 105-a may transmit OFDMA communications signals to a UE 115-a using a downlink 205. The downlink 205 is associated with a frequency F1 in an unlicensed spectrum. The base station 105-a may transmit OFDMA communications signals to the same UE 115-a using a bidirectional link 210 and may receive SC-FDMA communications signals from that UE 115-a using the bidirectional link 210. The bidirectional link 210 is associated with a frequency F4 in a licensed spectrum. The downlink 205 in the unlicensed spectrum and the bidirectional link 210 in the licensed spectrum may operate concurrently. The downlink 205 may provide a downlink capacity offload for the base station 105-a. In some embodiments, the downlink 205 may be used for unicast services (e.g., addressed to one UE) services or for multicast services (e.g., addressed to several UEs). This scenario may occur with any service provider (e.g., traditional mobile network operator or MNO) that uses a licensed spectrum and needs to relieve some of the traffic and/or signaling congestion.

In one example of a carrier aggregation mode in diagram 200, the base station 105-a may transmit OFDMA communications signals to a UE 115-a using a bidirectional link 215 and may receive SC-FDMA communications signals from the same UE 115-a using the bidirectional link 215. The bidirectional link 215 is associated with the frequency F1 in the unlicensed spectrum. The base station 105-a may also transmit OFDMA communications signals to the same UE 115-a using a bidirectional link 220 and may receive SC-FDMA communications signals from the same UE 115-a using the bidirectional link 220. The bidirectional link 220 is associated with a frequency F2 in a licensed spectrum. The bidirectional link 215 may provide a downlink and uplink capacity offload for the base station 105-a. Like the supplemental downlink described above, this scenario may occur with any service provider (e.g., MNO) that uses a licensed spectrum and needs to relieve some of the traffic and/or signaling congestion.

In another example of a carrier aggregation mode in diagram 200, the base station 105-a may transmit OFDMA communications signals to a UE 115-a using a bidirectional link 225 and may receive SC-FDMA communications signals from the same UE 115-a using the bidirectional link 225. The bidirectional link 225 is associated with the frequency F3 in an unlicensed spectrum. The base station 105-a may also transmit OFDMA communications signals to the same UE 115-a using a bidirectional link 230 and may receive SC-FDMA communications signals from the same UE 115-a using the bidirectional link 230. The bidirectional link 230 is associated with the frequency F2 in the licensed spectrum. The bidirectional link 225 may provide a downlink and uplink capacity offload for the base station 105-a. This example and those provided above are presented for illustrative purposes and there may be other similar modes of operation or deployment scenarios that combine LTE/LTE-A with or without unlicensed spectrum for capacity offload.

As described above, the typical service provider that may benefit from the capacity offload offered by using LTE/LTE-A with unlicensed spectrum is a traditional MNO with LTE spectrum. For these service providers, an operational configuration may include a bootstrapped mode (e.g., supplemental downlink, carrier aggregation) that uses the LTE primary component carrier (PCC) on the licensed spectrum and the LTE secondary component carrier (SCC) on the unlicensed spectrum.

In the supplemental downlink mode, control for LTE/LTE-A with unlicensed spectrum may be transported over the LTE uplink (e.g., uplink portion of the bidirectional link 210). One of the reasons to provide downlink capacity offload is because data demand is largely driven by downlink consumption. Moreover, in this mode, there may not be a regulatory impact since the UE is not transmitting in the unlicensed spectrum. There is no need to implement listen-before-talk (LBT) or carrier sense multiple access (CSMA) requirements on the UE. However, LBT may be implemented on the base station (e.g., eNB) by, for example, using a periodic (e.g., every 10 milliseconds) clear channel assessment (CCA) and/or a grab-and-relinquish mechanism aligned to a radio frame boundary.

In the carrier aggregation mode, data and control may be communicated in LTE (e.g., bidirectional links 210, 220, and 230) while data may be communicated in LTE/LTE-A with unlicensed spectrum (e.g., bidirectional links 215 and 225). The carrier aggregation mechanisms supported when using LTE/LTE-A with unlicensed spectrum may fall under a hybrid frequency division duplexing-time division duplexing (FDD-TDD) carrier aggregation or a TDD-TDD carrier aggregation with different symmetry across component carriers.

FIG. 2B shows a diagram 200-a that illustrates an example of a standalone mode for LTE/LTE-A with unlicensed spectrum. The diagram 200-a may be an example of portions of the system 100 of FIG. 1. Moreover, the base station 105-b may be an example of the base stations 105 of FIG. 1 and the base station 105-a of FIG. 2A, while the UE 115-b may be an example of the UEs 115 of FIG. 1 and the UEs 115-a of FIG. 2A.

In the example of a standalone mode in diagram 200-a, the base station 105-b may transmit OFDMA communications signals to the UE 115-b using a bidirectional link 240 and may receive SC-FDMA communications signals from the UE 115-b using the bidirectional link 240. The bidirectional link 240 is associated with the frequency F3 in an unlicensed spectrum described above with reference to FIG. 2A. The standalone mode may be used in non-traditional wireless access scenarios, such as in-stadium access (e.g., unicast, multicast). The typical service provider for this mode of operation may be a stadium owner, cable company, event hosts, hotels, enterprises, and large corporations that do not have licensed spectrum. For these service providers, an operational configuration for the standalone mode may use the PCC on the unlicensed spectrum. Moreover, LBT may be implemented on both the base station and the UE.

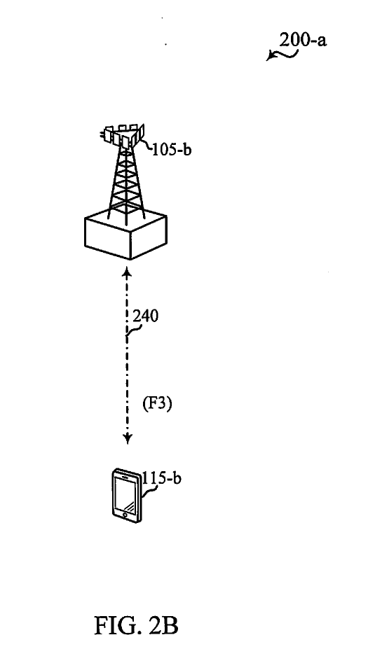

Turning next to FIG. 3, a diagram 300 illustrates an example of carrier aggregation when using LTE concurrently in licensed and unlicensed spectrum according to various embodiments. The carrier aggregation scheme in diagram 300 may correspond to the hybrid FDD-TDD carrier aggregation described above with reference to FIG. 2A. This type of carrier aggregation may be used in at least portions of the system 100 of FIG. 1. Moreover, this type of carrier aggregation may be used in the base stations 105 and 105-a of FIG. 1 and FIG. 2A, respectively, and/or in the UEs 115 and 115-a of FIG. 1 and FIG. 2A, respectively.

In this example, an FDD (FDD-LTE) may be performed in connection with LTE in the downlink, a first TDD (TDD1) may be performed in connection with LTE/LTE-A with unlicensed spectrum, a second TDD (TDD2) may be performed in connection with LTE with licensed spectrum, and another FDD (FDD-LTE) may be performed in connection with LTE in the uplink with licensed spectrum. TDD1 results in a DL:UL ratio of 6:4, while the ratio for TDD2 is 7:3. On the time scale, the different effective DL:UL ratios are 3:1, 1:3, 2:2, 3:1, 2:2, and 3:1. This example is presented for illustrative purposes and there may be other carrier aggregation schemes that combine the operations of LTE/LTE-A with or without unlicensed spectrum.

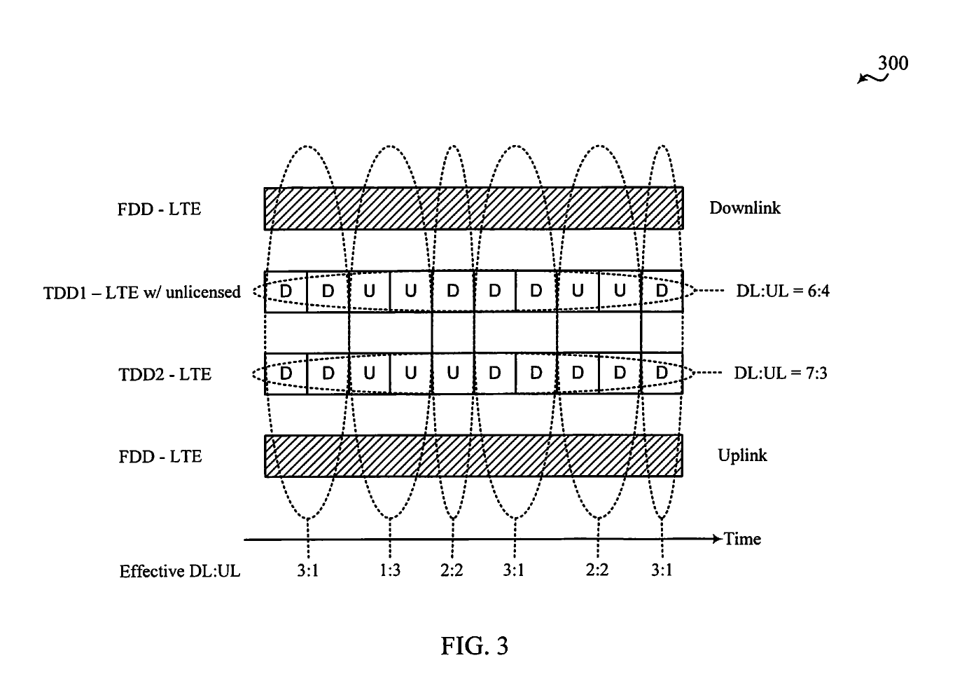

FIG. 4 shows a block diagram of a design of a base station/eNB 105 and a UE 115, which may be one of the base stations/eNBs and one of the UEs in FIG. 1. The eNB 105 may be equipped with antennas 434a through 434t, and the UE 115 may be equipped with antennas 452a through 452r. At the eNB 105, a transmit processor 420 may receive data from a data source 412 and control information from a controller/processor 440. The control information may be for the physical broadcast channel (PBCH), physical control format indicator channel (PCFICH), physical hybrid automatic repeat request indicator channel (PHICH), physical downlink control channel (PDCCH), etc. The data may be for the physical downlink shared channel (PDSCH), etc. The transmit processor 420 may process (e.g., encode and symbol map) the data and control information to obtain data symbols and control symbols, respectively. The transmit processor 420 may also generate reference symbols, e.g., for the primary synchronization signal (PSS), secondary synchronization signal (SSS), and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 115, the antennas 452a through 452r may receive the downlink signals from the eNB 105 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 115 to a data sink 460, and provide decoded control information to a controller/processor 480.

On the uplink, at the UE 115, a transmit processor 464 may receive and process data (e.g., for the physical uplink shared channel (PUSCH)) from a data source 462 and control information (e.g., for the physical uplink control channel (PUCCH)) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the eNB 105. At the eNB 105, the uplink signals from the UE 115 may be received by the antennas 434, processed by the modulators 432, detected by a MIMO detector 436 if applicable, and further processed by a receive processor 438 to obtain decoded data and control information sent by the UE 115. The processor 438 may provide the decoded data to a data sink 439 and the decoded control information to the controller/processor 440.

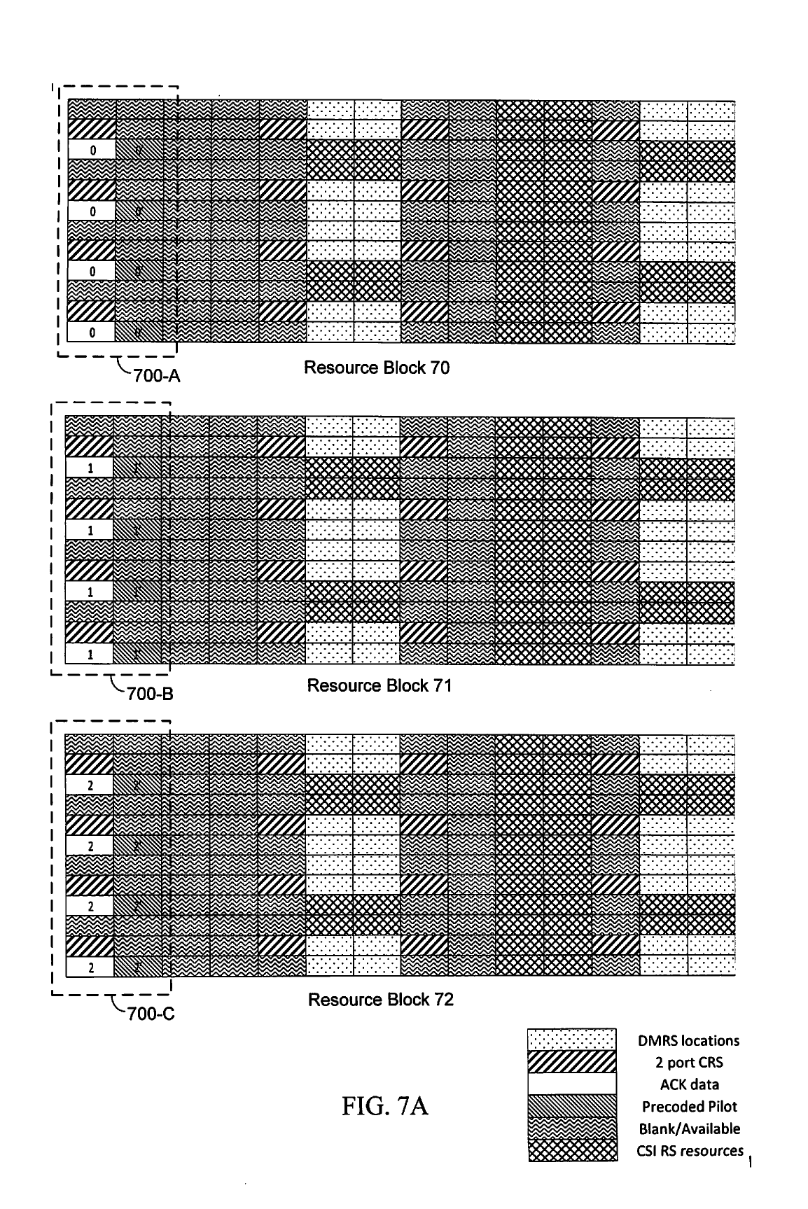

The controllers/processors 440 and 480 may direct the operation at the eNB 105 and the UE 115, respectively. The controller/processor 440 and/or other processors and modules at the eNB 105 may perform or direct the execution of various processes for the techniques described herein. The controllers/processor 480 and/or other processors and modules at the UE 115 may also perform or direct the execution of the functional blocks illustrated in FIGS. 8-11, and/or other processes for the techniques described herein. The memories 442 and 482 may store data and program codes for the eNB 105 and the UE 115, respectively. A scheduler 444 may schedule UEs for data transmission on the downlink and/or uplink.

In LTE systems, PHICH carries the downlink acknowledgement signals for UE uplink transmissions. The downlink acknowledgement signals identify a status of a particular uplink transmission. The downlink acknowledgement signal may be a positive acknowledgement (ACK), which indicates that the uplink data transmission was successfully received and demodulated, or may be a negative acknowledgement (NACK), which indicates that there was a failure in the receipt of the uplink data transmission, whether that failure was failure to entirely receive and/or failure to demodulate the received signals. In order to properly demodulate PHICH in existing LTE deployments, a UE will use the common reference signal (CRS). Because CRS is common to all users in the cell, each UE within the cell will receive CRS and be capable of determining the channel estimate from the CRS for decoding the PHICH, ACK, and the like.

LTE PHICH may be transmitted in either a normal or extended configuration. Normal configuration PHICH uses one OFDM symbol, while extended configuration PHICH uses three OFDM symbols. LTE PHICH are also configured using resource element groups (REGs). REGs form the building blocks for multiple channels, such as PCFICH, PHICH PDCCH, and the like. A REG is a group of three or four resource elements (REs) that are used to structure the mapping of these channels to resource elements in the OFDM symbols of each subframe.

In LTE/LTE-A networks with unlicensed spectrum and configured in the supplemental downlink (SDL) and carrier aggregation (CA) modes, ACKs for uplink transmissions are generally sent over the licensed band, though, ACKs could also be sent over the unlicensed band. Thus, as currently configured, downlink transmission of ACKs of uplink data may not be possible in standalone (SA) modes, where the LTE/LTE-A deployments have only unlicensed carrier bands. However, in unlicensed bands, a CRS may be transmitted only in subframes 0 and 5. Thus, UEs in communication using LTE/LTE-A with unlicensed spectrum would not typically be able to receive the CRS for purposes of channel estimation and decoding the ACK. In order to make use of communications using LTE/LTE-A with unlicensed spectrum, some other type of precoded signal may be used. In existing LTE systems, each resource element of a given resource block is precoded using the same precoding. In such systems, the precoding would only vary between different resource blocks. Existing PHICH configuration may run into capacity limitations when several UEs are being served on the unlicensed band. Various aspects of the present disclosure may provide an enhanced PHICH (EPHICH) that allows for ACKs to be transmitted using the unlicensed carrier bands in LTE/LTE-A with unlicensed spectrum.

In general, the sequence generation of ACK/NACK for LTE/LTE-A with unlicensed spectrum may be the same as in LTE/LTE-A without unlicensed spectrum. An ACK/NACK bit will be repeated three times and spread with length code of four to generate a 12 symbol acknowledgement sequence. For example, for an ACK=1, repetition=[1 1 1], with a spreading=[1 1-1-1 1 1-1-1 1 1-1-1], using binary phase-shift keying (BPSK) modulation. Thus, a total of eight ACK/NACK bits may be multiplexed on the same set of resources for an acknowledgement sequence: e.g., four ACK/NACK bits due to spreading, with one bit set on in-phase and another bit set on the quadrature carrier (4×2=8).

According to various aspects of the present disclosure, the EPHICH design provides the capability for each REG to have independent precoding. This independent precoding may be matched to the particular configuration of a UE or a particular carrier, such that acknowledgement signals for multiple UEs or multiple carriers may be included in a single EPHICH.

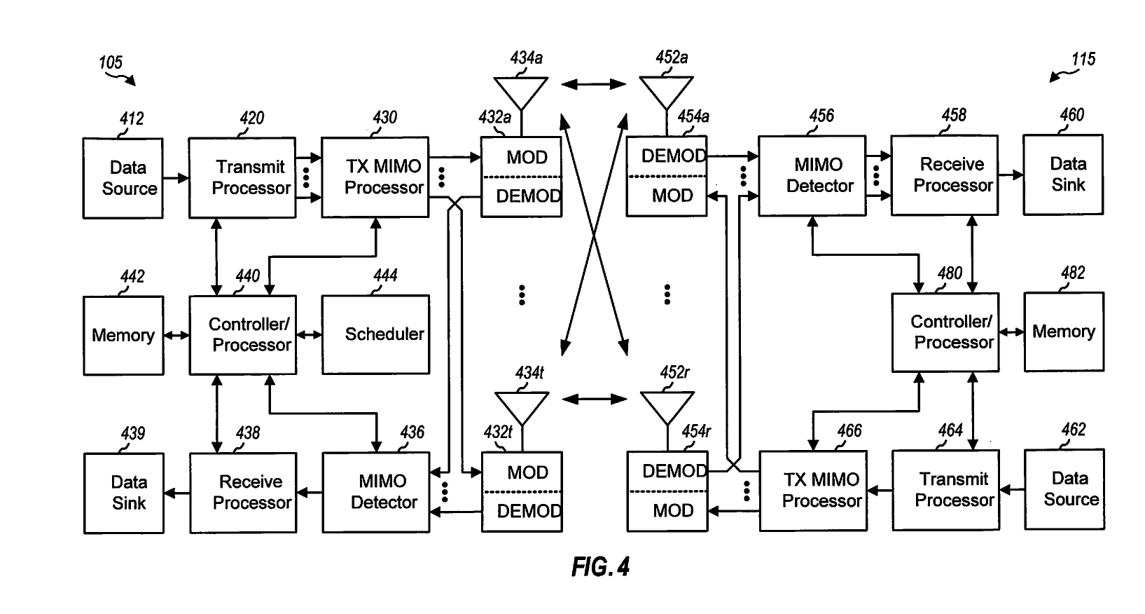

In order to achieve the EPHICH design according to the various aspects, all of the REGs in an EPHICH are divided into paired data and pilot REGs. Accordingly, acknowledgment data may be mapped to the data REGs. FIG. 5 is a block diagram illustrating a downlink resource block 50 configured according to one aspect of the present disclosure. Each square of downlink resource block 50 represents a resource element (RE). As illustrated in FIG. 5, groups of four REs are associated as REGs. The pilot REGs are shown having prime superscripts, while the data REGs have the regular numbers. REG pair 500 includes the data REG of 0's paired with the pilot REG of 0's. When generating the ACK bits for the data REGs, the output of Walsh spreading of the ACK bits is precoded using the same precoding as the paired pilot REGs. Because each of the REGs in the pair are precoded using the same precoding, each of the paired REGs in one PHICH may have a different precoding. For example, the precoding for REG pair 500 may be different than the precoding for REG pair 501.

Aspects of the present disclosure provide for the precoding of paired REGs to match or be associated with a particular UE or carrier. Therefore, each served UE detects the precoding of the pilot REGs of the EPHICH to determine which paired REG is associated to that UE or to a particular carrier. The UE may then use the precoding to generate a channel estimate for decoding the data REG for the acknowledgement signal.

It should be noted that additional aspects may use precoder cycling, which could provide additional diversity. It should further be noted that, for adjacent REGs, such as REGs 0,1,2,3,4,5, the channel may be assumed to be the same on adjacent subcarriers.

Downlink resource block 50 also includes resource elements that are reserved for channel state information reference signals (CSI-RS). The transmitting base stations will still transmit the CSI-RS in the allocated resources. Therefore, no acknowledgement data would be transmitted in these resource elements, such as in block 503. Demodulation reference signals (DM-RS) are also allocated within downlink resource block 50, for example, at block 502. However, the serving base station will use these allocated resource elements for data and pilot transmissions as well.

As noted above, an acknowledgement sequence may be generated over a 12 symbol sequence when using a 4×4 Walsh sequence spreading. In FIG. 5, each REG is made up of 4 symbol sequences. Therefore, each acknowledgement sequence includes three data REGs, when using the 4×4 Walsh sequence spreading. Considering the resource elements designated for CSI-RS, there are 16 paired REGs in each EPHICH resource block. Because three REGs are used for each acknowledgement sequence, there are 15 usable data REGs per resource block with the EPHICH configuration, which results in five acknowledgement sequences per EPHICH resource block. With eight possible acknowledgement bits that may be multiplexed over a single acknowledgement sequence, a single resource block EPHICH configuration may accommodate up to 40 acknowledgement bits. EPHICH configured in the compressed mode are generated using only one resource block. Therefore, compressed mode EPHICH have a capacity of 40 acknowledgement bits/signals.

When configured as a normal mode EPHICH, a plurality of resource blocks may be used. For example, when three resource blocks total are used, 48 REGs (3×16 REGs), which yields 16 usable acknowledgement sequence groups (48 REGs ÷3). Therefore, the capacity for normal mode EPHICH would be 128 acknowledgment bits/signals (16 groups×8).

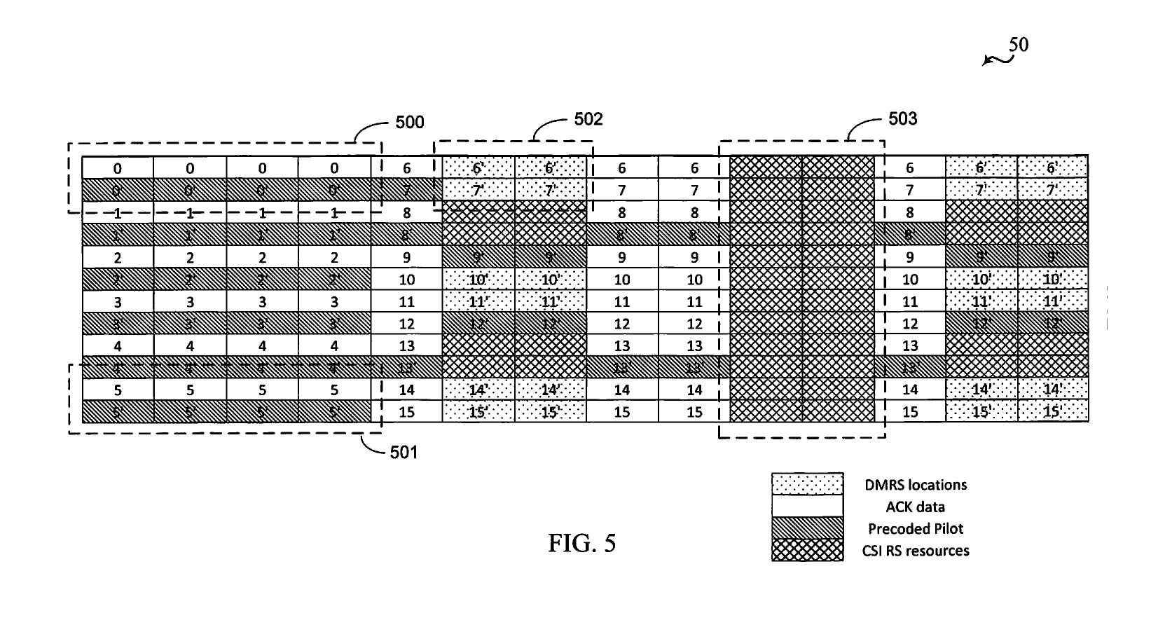

FIG. 6 is a block diagram illustrating a downlink resource block 60 configured according to one aspect of the present disclosure. In some aspects a base station may use 2 ports for CRS. Downlink resource block 60 provides a configuration for EPHICH with 2-port CRS. Downlink resource block 60 includes paired resource element groups, such as resource element group 600. However, because of resource elements allocated for the 2-port CRS and other blank subcarriers in blocks 601 and 602, resource element groups 1,2,4 and 5 only have three resource elements available for the group. While a resource element group may include only three resource elements, because Walsh spreading uses a 4×4 code, aspects of the disclosure including 2-port CRS configuration may use a 3×3discrete Fourier transform (DFT) matrix columns-based spreading instead. It should be noted that other forms of 3×3 spreading codes may be used. The specific example encoding and spreading mechanisms identified herein are intended merely for example. Because some of the resource elements are now occupied by CRS resources and some resource may then be left blank to accommodate the REGs, the overall capacity of EPHICH is reduced in such 2-port CRS configurations. For example, given the 3×3 DFT matrix column-based spreading, compressed mode EPHICH capacity is reduced to 32 bits (4 groups×8 bits), while normal mode EPHICH capacity is reduced to bits (12 groups×8 bits).

It should be noted that additional frequency diversity may be achieved in normal mode EPHICH by spreading the EPHICH resource blocks across the system bandwidth.

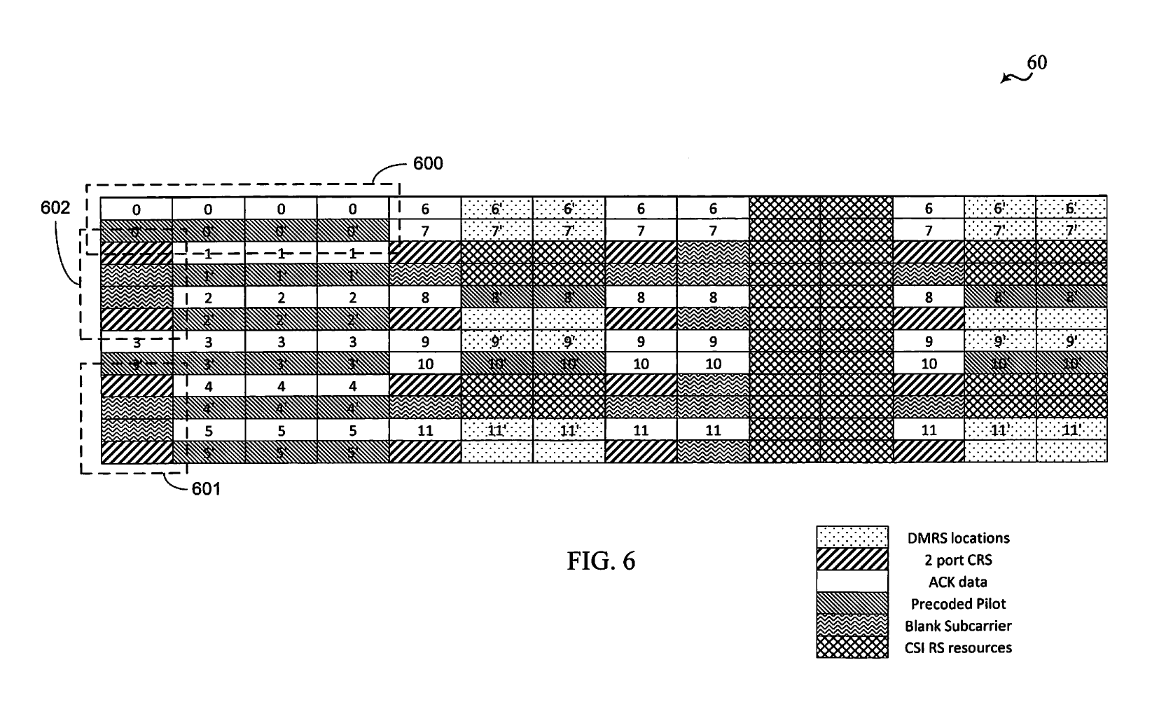

FIGS. 7A and 7B are block diagrams illustrating a plurality of downlink resource blocks (RBs) 70-72 (FIG. 7A) and RBs 73-75 (FIG. 7B) configured according to aspects of the present disclosure. The base station associated with downlink RBs 70-72 and RBs 73-75 also uses 2 ports for CRS. Thus, downlink RBs 70-72 and RBs 73-75 include additional resource elements occupied by 2-port CRS resources, as in FIG. 6. In various alternative aspects of the present disclosure, it may be beneficial to spread each REG of an acknowledgment sequence over a different RB. For example, FIGS. 7A and 7B illustrate REGs of an acknowledgement sequence located on separate RBs. In FIG. 7A, REG 700-A, in which the data REs and the pilot REs are located in different symbol period, is located on RB 70, while REG 700-B is located on RB 71, and REG 700-C is located on RB 72. In FIG. 7B, REG 701-A, in which the data and pilot REs are located in the same symbol period, is located on RB 73, while REG 701-B is located on RB 72, and REG 701-C is located on RB 73. It should be noted that the RBs 70-72 and RBs 73-75 are illustrated in FIGS. 7A and 7B for purposes of describing the example aspects. Thus, in application, RBs 70-72 and RBs 73-75 may be consecutive or non-consecutive RBs. Using this type of configuration in which REGs of the same acknowledgement sequence are separated among different RBs, only a few REs from each of the RBs are used, which leaves additional REs available within each RB, e.g., RBs 70-72 and RBs 73-75. These additional REs may be used for scheduling data, which would reduce EPHICH overhead.

Implementations of the example alternative aspects of FIGS. 7A and 7B may provide for the locations of the RBs carrying the EPHICH to be signaled to all of the UEs in the cell, where the PDSCH can be rate-matched around the EPHICH. Alternatively, each of the UEs in the cell may only know the location of its own EPHICH, where the serving base station would puncture the PDSCH on those resources used for the EPHICH. UEs may determine the location of their own EPHICH from the first RB of their uplink grant for which the ACK is sent. Various other mechanisms may be used for signaling the location of EPHICH to UEs when the EPHICH REGs are split across multiple RBs. The present disclosure is not limited to any particular methodology.

The configuration of EPHICH allows for multiple acknowledgement signals or bits to be accommodated for multiple UEs or multiple carriers, all within the same EPHICH subframes. Thus, transmitting EPHICH in a deployment using LTE/LTE-A with unlicensed spectrum allows for a single EPHICH to be transmitted, when allowed, over unlicensed bands and have the capacity for holding the acknowledgement signals for multiple UE uplink signals. FIG. 8 is a functional block diagram illustrating example blocks executed to implement one aspect of the present disclosure. At block 800, a base station generates a plurality of acknowledgment signals, wherein each of the plurality of acknowledgement signals corresponds to status of a plurality of uplink signals. In normal operations, uplink signals transmitted from various UEs, such as UE 115 (FIG. 4), in a particular cell are received and demodulated by the serving base station, such as base station 105 (FIG. 4). When the base station fails to properly demodulate the uplink signals, the base station will send a negative acknowledgement (NACK) to the UE originating the uplink signal that failed to demodulate. If the base station does properly demodulate the uplink signal, a positive acknowledgement (ACK) is transmitted to the originating UE instead. In the described aspect, base station 105 attempts to decode the incoming uplink signals from the UEs being served and formulates or generates each of the acknowledgement messages for the corresponding UE.

At block 801, the base station multiplexes the plurality of acknowledgement signals into an acknowledgment indicator channel, wherein the acknowledgement indicator channel includes a plurality of data resource element groups and a plurality of pilot resource element groups paired with the plurality of data resource element groups. The base station, such as base station 105, is configured according to the aspects of the present disclosure. With multiple acknowledgement bits for multiple UEs, base station 105 multiplexes, up to the capacity of acknowledgement bits, the acknowledgement messages for the corresponding UEs onto an acknowledgement indicator channel. An acknowledgment indicator channel may be physical layer channel, such as an EPHICH, or any other type of communication channel known for carrying acknowledgement indication. The acknowledgment indicator channel includes multiple data resource element groups and multiple pilot resource element groups that are paired together to form paired resource element groups.

At block 802, the base station precodes one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding. The base station, such as base station 105, may precode each paired resource element or paired resource element group with its own precoding. The resulting precoding may provide for independently precoded paired resource elements or paired resource element groups. Because the paired resource elements are precoded, a data resource element or resource element group has the same precoding as the paired pilot resource element or resource element group. This independent precoding in which a paired data and pilot resource element allows for any of the served UEs to detect its particular acknowledgement message by detecting the precoding that matches or is associated with the particular UE configuration.

At block 803, the base station transmits the acknowledgment indicator channel. Once the EPHICH has been formed by multiplexing the multiple acknowledgement messages and independently precoding each of the paired resource elements or paired resource element groups, the base station, such as base station 105, transmits the acknowledgement indicator channel. When transmitting over an unlicensed band in an LTE/LTE-A network with unlicensed spectrum, the base station would first perform listen before talk (LBT) procedures, such as by performing clear channel assessment (CCA) checks. The EPHICH may then be transmitted on the unlicensed carrier with a clear CCA.

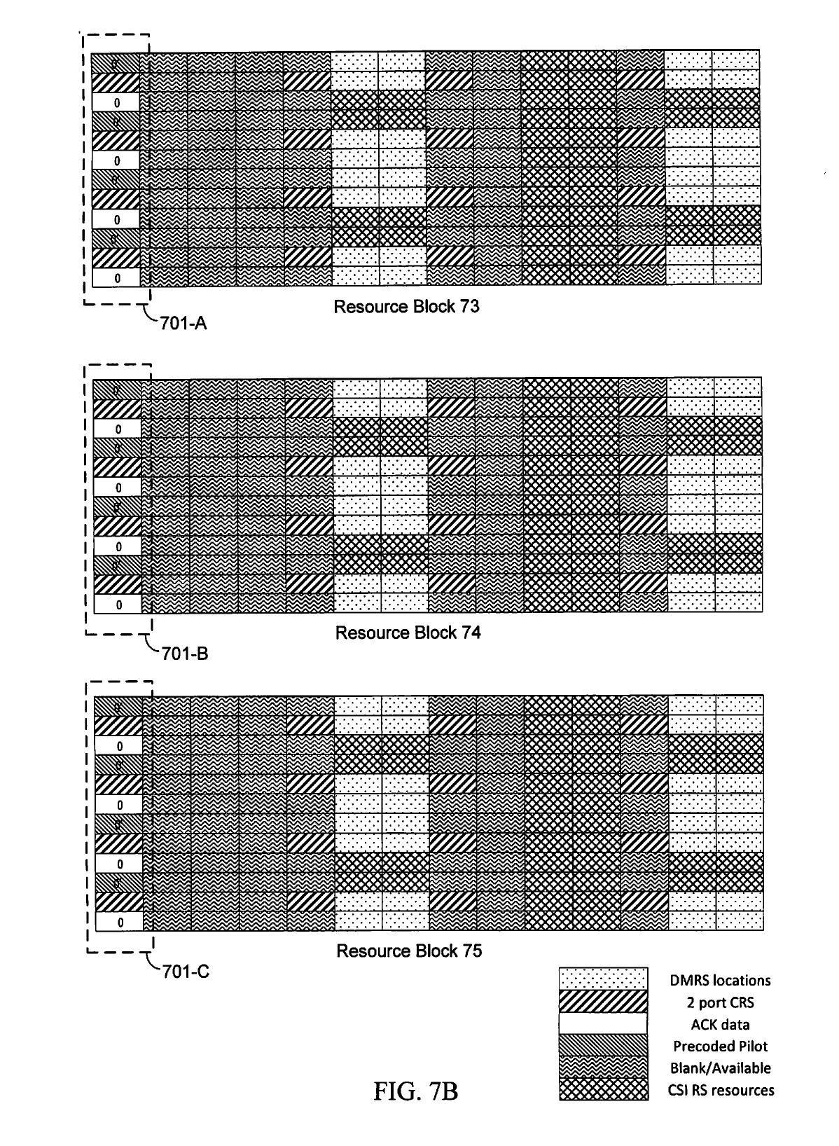

On the UE side, the UE does not change its uplink transmission procedures, but would adjust downlink receiving to find acknowledgements in an EPHICH. FIG. 9 is a functional block diagram illustrating example blocks executed to implement one aspect of the present disclosure. At block 900, a UE determines a downlink resource for receiving an acknowledgement indicator channel. A UE, such as UE 115 (FIG. 4) knows over which resources to expect to receive acknowledgement. UE 115, therefore, determines which of the downlink resources are identified for receiving the acknowledgement indicator channel, such as the EPHICH, and the like.

At block 901, the UE detects one or more pilot resource element groups of the acknowledgement indicator channel having a precoding corresponding to a configuration of the UE. When receiving the acknowledgement indicator channel on the designated resources, the UE, such as UE 115, searches for precoding on each of the pilot resource element groups contained within the acknowledgement indicator channel. UE 115 searches for the precoding that matches or corresponds to its own configuration.

At block 902, the UE determines a channel estimate for the acknowledgement indicator channel, wherein the channel estimate is based on the detected corresponding precoding. In order to demodulate the acknowledgement indicator channel and, thus, the acknowledgement messages, correctly, the UE, such as UE 115, first determines a channel estimate. After detecting the precoding that corresponds to the UE's configuration, UE 115 determines a channel estimate based on the detected precoding.

At block 903, the UE then decodes one or more data resource element groups paired with the one or more pilot resource element groups using the channel estimate to obtain an acknowledgement related to an uplink signal transmitted by the UE, wherein the one or more data resource element groups are precoded using the precoding of the detected one or more pilot resource element groups. After detecting the corresponding precoding of the pilot resource element group associated with the UE, the UE, such as UE 115, uses the channel estimate determined from the precoding to decode and demodulate the acknowledgement message in the data resource element group paired and precoded using the same precoding as the detected pilot resource element group.

In generating the channel estimation, the UE uses the paired resource element group for precoded channel estimation. It should further be noted that noise and interference estimation may be enhanced in various aspects of the present disclosure by measuring any unused CSI-RS resources. With reference to FIGS. 5-7, each of downlink resource blocks 50, 60, and 70-72 includes unused resources that are reserved for CSI-RS. The UE configured according to the various aspects described herein may use these unused resources to better estimate noise and interference. A UE may use blind detection in order to determine the unused resources.

Typically, PHICH are carried in the first symbol of the first subframe. Similar determination of resources may be used for EPHICH at the UE. Moreover, because EPHICH will not be located in the same resource block as EPDCCH and PDCCH is not used in LTE/LTE-A networks with unlicensed spectrum, no signaling in the master information block (MIB) would be needed as there would be no conflict among EPHICH and EPDCCH resources.

As configured according to the various aspects of the present disclosure, the EPHICH configurations have a high capacity, e.g., uplink transmissions on multiple carriers and from multiple UEs can be acknowledged using the same EPHICH. When deployed in networks operating LTE/LTE-A with unlicensed spectrum, EPHICH may be transmitted on any downlink carrier that detects a clear CCA check. If multiple downlink carriers are available because of multiple clear CCA checks, the eNB or base station may select one of the carriers in a manner which will be known or understood by the UE. For example, the selection criteria known to each network entity (e.g., base station, eNB, UE, and the like) may provide for selection of the lowest frequency carrier, the carrier having the lowest carrier indication field (CIF), or the like. As long as the UEs are also aware of the selection or selection mechanism, any means for selecting the EPHICH transmission carrier may be successful.

Additional aspects of the present disclosure provide for an alternative acknowledgement process. For example, when there is no downlink data at a base station for transmission to any of its served UEs, transmitting a resource block for EPHICH, in addition to other placeholder transmissions, which are required to meet certain bandwidth requirements when using unlicensed spectrum, may be a waste of resources. In one alternative aspects, instead of transmitting acknowledgements through EPHICH, acknowledgement messages may be implicitly transmitted using EPDCCH. If a particular uplink transmission is not accurately demodulated by the base station, it will transmit a re-grant of resources for retransmission of the particular uplink signals. By receiving the grant of resources to retransmit previously transmitted uplink signals, the UE implicitly receives a negative acknowledgment. If no such re-grant of resources is received and no ACK is received by the UE, then it may imply a positive acknowledgement.

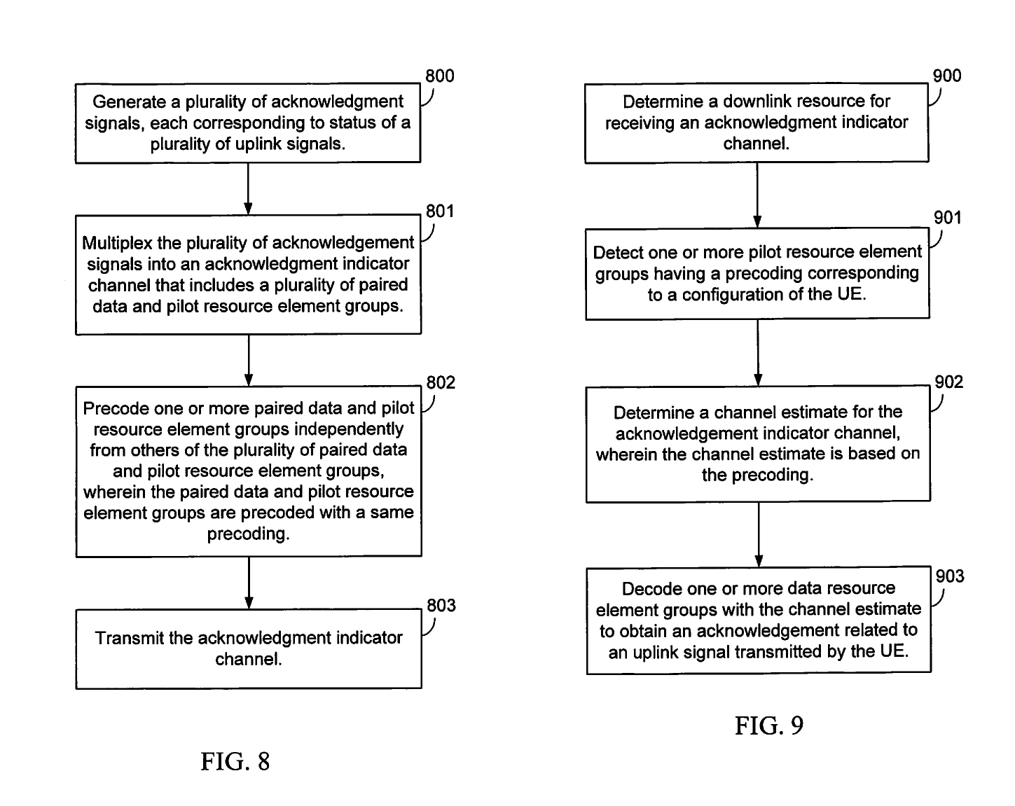

FIG. 10 is a functional block diagram illustrating example blocks executed to implement one aspect of the present disclosure. At block 1000, a base station determines a failure to decode one or more uplink signals of uplink signals received from one or more UEs served by the base station. As noted above, during the normal course of communication between a base station, such as base station 105, and its served UEs, a base station, for any number of reasons, may not successfully decode an uplink signal.

At block 1001, the base station generates one or more uplink grants for retransmission of the one or more uplink signals in response to the failure to decode. In the alternative aspect, instead of generating an acknowledgement message and sending the message over an acknowledgement indicator channel, base station 105, configured according to the alternative aspect, generates resource grants for retransmission of the uplink signals that failed to decode.

At block 1002, the base station transmits the one or more uplink grants in a downlink control channel. The base station, such as base station 105, includes the resource grants (e.g., re-grants) for retransmission into a downlink control channel, such as EPDCCH, and the like, and transmits to the corresponding UE.

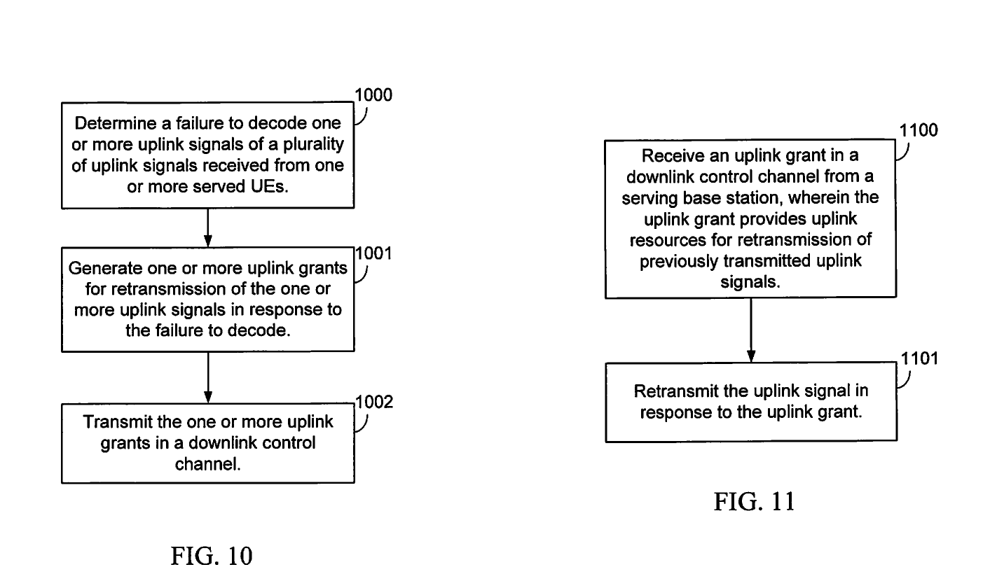

On the UE side, in one example aspect, the UE will know not to expect direct acknowledgement messages, but wait for re-grants for failed uplink transmissions. FIG. 11 is a functional block diagram illustrating example blocks executed to implement one aspect of the present disclosure. At block 1100, the UE receives an uplink grant in a downlink control channel from a serving base station, wherein the uplink grant provides uplink resources for retransmission of an uplink signal previously transmitted by the UE. A UE, such as UE 115, knows it will not receive direct acknowledgements for previous uplink transmission and, thus, waits to detect any re-grants contained with a downlink control channel, such as EPDCCH, or the like. At block 1102, the UE retransmits the uplink signal in response to the uplink grant. After receiving the re-grant of resources for transmitting the previously transmitted signals, the UE, such as UE 115, retransmits the uplink signals.

It should be noted that in some additional aspects of the present disclosure where implicit acknowledgements are used, an acknowledgement may be indicated asynchronously, for example, if no clear CCA checks occur within the type acknowledgement period or if another type of periodicity is used. Because such acknowledgements may not be at a predictable transmission rate, the base station will attach or send additional signaling that identifies which subframe or which particular uplink transmission is associated with the acknowledgement message.

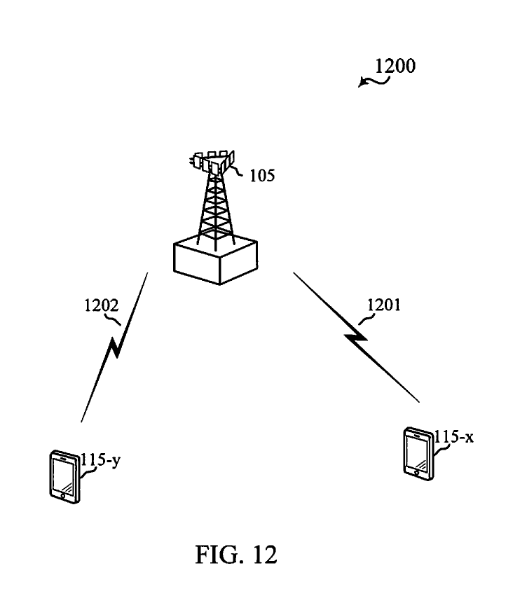

FIG. 12 is a block diagram illustrating a network 1200 operating LTE/LTE-A with unlicensed spectrum and configured according to one aspect of the present disclosure. Network 1200 includes base station 105 serving UEs 115-x and 115-y. Network 1200 uses unlicensed spectrum 1201-1202 to communicate with UEs 115-x and 115-y and is configured to use EPHICH for acknowledgement signals when base station 105 has downlink data for either of UEs 115-x or 115-y, and to use implicit acknowledgment, through EPDCCH, when base station 105 does not have downlink data for either of UEs 115-x or 115-y. In one example instant, base station 105 has downlink data for delivery to UE 115-x, but no downlink data for UE 115-y. In one aspect of the present disclosure, acknowledgements for UE 115-x are included in a EPHICH, while acknowledgements for UE 115-y are implicitly communicated using re-granting through EPDCCH from base station 105 to UE 115-y.

Additional aspects of the present disclosure would provide for implicit acknowledgments using EPDCCH only in subframes when base station 105 has no data for downlink communication to both of UEs 115-x and 115-y. Otherwise, acknowledgements are multiplexed onto EPHICH for all of the served UEs. Therefore, in the respective aspects, implicit acknowledgements through EPDCCH will only be used when base station 105 has no downlink data for both of UEs 115-x and 115-y.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 8-11 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination.

The previous description of the disclosure is provided to enable any person skilled in the art to make or use the disclosure. Various modifications to the disclosure will be readily apparent to those skilled in the art, and the generic principles defined herein may be applied to other variations Without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
generating a plurality of acknowledgment signals, wherein each of the plurality of acknowledgement signals corresponds to status of a plurality of uplink signals;
multiplexing the plurality of acknowledgement signals into an acknowledgment indicator channel, wherein the acknowledgement indicator channel includes a plurality of data resource element groups and a plurality of pilot resource element groups paired with the plurality of data resource element groups;
precoding one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding; and
transmitting the acknowledgment indicator channel.

2. The method of claim 1, wherein the precoding of the one or more data resource element groups precodes to match:
a configuration of one or more user equipments (UEs) corresponding to at least one of the plurality of uplink signals; or
one or more carriers over which one or more of the plurality of uplink signals was received.

3. The method of claim 1, wherein the acknowledgement indicator channel is configured with one resource block, the method further including:
cycling the precoding across each of the plurality of data resource element groups.

4. The method of claim 1, wherein the acknowledgment indicator channel is configured with a plurality of resource blocks, the method further including:
spreading the plurality of resource blocks of the acknowledgment indicator channel over a system bandwidth allocated to the base station.

5. The method of claim 1, wherein the acknowledgment indicator channel is configured with a plurality of resource blocks, the method further including:
spreading each of the plurality of data resource element groups and each of the paired plurality of pilot resource element groups associated with a single acknowledgement sequence of the plurality of acknowledgement signals in the acknowledgement indicator channel into a separate resource block of the plurality of resource blocks.

6. The method of claim 5, further including:
broadcasting a location of each of the plurality of resource blocks carrying the acknowledgement indicator channel to each user equipment (UE) served by the base station;
rate-matching downlink shared channels around the acknowledgement indicator channel; and
puncturing downlink shared channels on one or more resources used for the acknowledgement indicator channel.

7. The method of claim 1, further including:
selecting a downlink carrier from a plurality of available downlink carriers for the transmitting, wherein the downlink carrier is selected based on criteria commonly-known by one or more UEs served by a base station.

8. The method of claim 7, wherein the criteria includes one of:
a lowest carrier frequency of the plurality of available downlink carriers; or
a lowest carrier indication field of the plurality of available downlink carriers.

9. The method of claim 1, further including:
determining that there is no downlink data for transmission from a base station;
generating one or more uplink grants for retransmission of one or more uplink signals of the plurality of uplink signals, wherein the one or more uplink signals correspond to one or more acknowledgement signals indicating a negative acknowledgment for the one or more uplink signals;
transmitting the one or more uplink grants in a downlink control channel; and
suspending the transmitting of the acknowledgment indicator channel in response to determining no downlink data.

10. The method of claim 9, further including:
generating one or more identifier signals identifying a subframe corresponding to the one or more uplink signals; and
transmitting the one or more identifier signals to corresponding ones of the one or more UEs associated with the one or more uplink signals.

11. A method of wireless communication, comprising:
determining a downlink resource for receiving an acknowledgment indicator channel;
detecting one or more pilot resource element groups of the acknowledgement indicator channel having a precoding corresponding to a configuration of a user equipment (UE);
determining a channel estimate for the acknowledgement indicator channel, wherein the channel estimate is based on the precoding; and
decoding, using the channel estimate, one or more data resource element groups paired with the one or more pilot resource element groups in the acknowledgement indicator channel to obtain an acknowledgement related to an uplink signal transmitted by the UE, wherein the one or more data resource element groups are precoded using the precoding of the detected one or more pilot resource element groups.

12. The method of claim 11, wherein each of the plurality of data resource element groups and each of the paired plurality of pilot resource element groups associated with a single acknowledgement sequence of the plurality of acknowledgement signals in the acknowledgement indicator channel are spread into a separate resource block of the plurality of resource blocks.

13. The method of claim 12, further including one of:
receiving a location of each of the plurality resource blocks carrying the acknowledgement indicator channel associated with the UE; or
determining the location of each of the plurality resource blocks.

14. The method of claim 11, further including:
selecting a downlink carrier from a plurality of available downlink carriers for the downlink resource, wherein the downlink carrier is selected based on criteria commonly-known by the UE and a base station transmitting the acknowledgement indicator channel.

15. The method of claim 14, wherein the criteria includes one of:
a lowest carrier frequency of the plurality of available downlink carriers; andor
lowest carrier indication field of the plurality of available downlink carriers.

16. The method of claim 11, further including:
failing to detect the acknowledgement indicator channel within the downlink resource;
receiving an uplink grant in a downlink control channel, wherein the uplink grant provides uplink resources for retransmission of the uplink signal; and
retransmitting the uplink signal in response to the uplink grant.

17. The method of claim 16, further including:
receiving an identifier signal identifying a subframe corresponding to the uplink signal identified in the uplink grant, wherein the uplink signal retransmitted is the uplink signal corresponding to the identified subframe.

18. A non-transitory computer-readable medium having program code recorded thereon, comprising:
program code for causing a computer to generate a plurality of acknowledgment signals, wherein each of the plurality of acknowledgement signals corresponds to status of a plurality of uplink signals;
program code for causing the computer to multiplex the plurality of acknowledgement signals into an acknowledgment indicator channel, wherein the acknowledgement indicator channel includes a plurality of data resource element groups and a plurality of pilot resource element groups paired with the plurality of data resource element groups;
program code for causing the computer to precode one or more data resource element groups of the plurality of data resource element groups and one or more corresponding pilot resource element groups of the plurality of pilot resource element groups independently from others of the plurality of data resource element groups and plurality of pilot resource element groups, wherein the one or more data resource element groups and the one or more corresponding pilot resource element groups are precoded with a same precoding; and
program code for causing the computer to transmit the acknowledgment indicator channel.

19. The non-transitory computer-readable medium of claim 18, wherein the program code for causing the computer to precode the one or more data resource element groups causes the computer to precode to match:
a configuration of one or more user equipments (UEs) corresponding to at least one of the plurality of uplink signals; or
one or more carriers over which one or more of the plurality of uplink signals was received.

20. The non-transitory computer-readable medium of claim 18, wherein the acknowledgement indicator channel is configured with one resource block, the non-transitory computer-readable medium further including:
program code for causing the computer to cycle the program code for causing the computer to precode across each of the plurality of data resource element groups.

21. The non-transitory computer-readable medium of claim 18, wherein the acknowledgment indicator channel is configured with a plurality of resource blocks, the non-transitory computer-readable medium further including:
program code for causing the computer to spread the plurality of resource blocks of the acknowledgment indicator channel over a system bandwidth allocated to a base station.

22. The non-transitory computer-readable medium of claim 18, wherein the acknowledgment indicator channel is configured with a plurality of resource blocks, the computer program product further including:
program code for causing the computer to spread each of the plurality of data resource element groups and each of the paired plurality of pilot resource element groups associated with a single acknowledgement sequence of the plurality of acknowledgement signals in the acknowledgement indicator channel into a separate resource block of the plurality of resource blocks.

23. The non-transitory computer-readable medium of claim 18, further including:
program code for causing the computer to select a downlink carrier from a plurality of available downlink carriers for the transmitting, wherein the downlink carrier is selected based on criteria commonly-known by one or more UEs served by a base station, wherein the criteria includes one of
a lowest carrier frequency of the plurality of available downlink carriers; or
a lowest carrier indication field of the plurality of available downlink carriers.

24. An apparatus configured for wireless communication, the apparatus comprising:
at least one processor; and
a memory coupled to the at least one processor,
wherein the at least one processor is configured:
to generate a plurality of acknowledgment signals, wherein each of the plurality of acknowledgement signals corresponds to status of a plurality of uplink signals;
to multiplex the plurality of acknowledgement signals into an acknowledgment indicator channel, wherein the acknowledgement indicator channel includes a plurality of data resource element groups and a plurality of pilot resource element groups paired with the plurality of data resource element groups;
to precode one or more data resource element groups of the plurality of data resource element groups and one or more corresponding pilot resource element groups corresponding of the plurality of pilot resource element groups independently from others of the plurality of data resource element groups and plurality of pilot resource element groups, wherein the one or more data resource element groups and the one or more corresponding pilot resource element groups are precoded with a same precoding; and
to transmit the acknowledgment indicator channel.

25. The apparatus of claim 24, wherein the configuration of the at least one processor to precode the one or more data resource element groups configures the at least one processor to precode to match:
a configuration of one or more user equipments (UEs) corresponding to at least one of the plurality of uplink signals; or
one or more carriers over which one or more of the plurality of uplink signals was received.

26. The apparatus of claim 24, wherein the acknowledgement indicator channel is configured with one resource block, the configuration of the at least one processor further includes configuration to cycle the precoding across each of the plurality of data resource element groups.

27. The apparatus of claim 24, wherein the acknowledgment indicator channel is configured with a plurality of resource blocks, the configuration of the at least one processor further includes configuration to spread the plurality of resource blocks of the acknowledgment indicator channel over a system bandwidth allocated to the base station.

28. The apparatus of claim 24, wherein the acknowledgment indicator channel is configured with a plurality of resource blocks, the configuration of the at least one processor further including configuration to spread each of the plurality of data resource element groups and each of the paired plurality of pilot resource element groups associated with a single acknowledgement sequence of the plurality of acknowledgement signals in the acknowledgement indicator channel into a separate resource block of the plurality of resource blocks, and wherein the at least one processor is further configured to one of:
broadcast a location of each of the plurality of resource blocks carrying the acknowledgement indicator channel to each user equipment (UE) served by the base station, and rate-match, by the base station, downlink shared channels around the acknowledgement indicator channel; or
puncture downlink shared channels on one or more resources used for the acknowledgement indicator channel.

29. The apparatus of claim 24, further including configuration of the at least one processor to select a downlink carrier from a plurality of available downlink carriers for the transmitting, wherein the downlink carrier is selected based on criteria commonly-known by one or more UEs served by a base station, wherein the criteria includes one of:
a lowest carrier frequency of the plurality of available downlink carriers; or
a lowest carrier indication field of the plurality of available downlink carriers.

30. The apparatus of claim 24, further including configuration of the at least one processor:
to determine that there is no downlink data for transmission from the base station;
to generate one or more uplink grants for retransmission of one or more uplink signals of the plurality of uplink signals, wherein the one or more uplink signals correspond to one or more acknowledgement signals indicating a negative acknowledgment for the one or more uplink signals;
to transmit the one or more uplink grants in a downlink control channel;
to suspend the program code for causing the computer to transmit of the acknowledgment indicator channel in response to determining no downlink data;
to generate one or more identifier signals identifying a subframe corresponding to the one or more uplink signals; and
to transmit the one or more identifier signals to corresponding ones of the one or more UEs associated with one or more uplink signals.
